(19) United States
(12) Patent Application Publication
(10) Pub. No.: US 2009/0240529 A1
(43) Pub. Date: Sep. 24, 2009

(54) Method for selecting a high risk patient for participation in a care management program for patients having poor prognoses

(75) Inventors: David Mark Chess, Stratford, CT (US); Mary Krentzman, Southbury, CT (US)

Correspondence Address: KENNETH F. PEARCE, 631 DENMARK DRIVE, DANVILLE, KY, 40422-2419, US

(73) Assignee: Enhanced Care Initiatives, Inc.

(21) Appl. No.: 12/454,952

(22) Filed: May 27, 2009

Related U.S. Application Data
(63) Continuation of application No. 10/745,786, filed on Dec. 27, 2003, now abandoned.

(51) Int. Cl. G06Q 50/00; G06Q 40/00; G06F 17/30; G06N 5/02

(52) U.S. Cl. 705/3; 705/2; 705/4; 705/30; 705/10; 707/5; 706/54; 707/E17.108

(57) ABSTRACT

The method of the present invention is used to select high risk or co-morbid patients for participation in a care management program. An acuity score determines which patients are selected for care management.

### BACKGROUND OF THE INVENTION

1. Field of the Invention

Among other things, the present invention is related to methods of selecting high risk patients for participation in a care management program. The method the present invention generates an acuity score that determines whether the potential patient is selected for participation in the care management program. A questionnaire provides questions for the interviewer to propound, via telephony, toward the potential high risk patient. The responses elicited from the potential high risk patient are a crucial component of the potential patient's multi-component acuity score.

2. Description of the Previous Art

1) U.S. Pat. No. 5,908,383—Brynjestad enables an interactive knowledge-based expert system for pain management. The '383 Pain Manager Advisor (PMA) incorporates the wisdom and experience of top pain management specialists. Brynjestad's PMA system permits inclusion of the latest knowledge regarding elicitation of relevant signs and symptoms of pain and its associated processes, accurate and complete diagnosis of the cause of pain, selection of optimum pain relief methods including alternatives, risks and benefits, options for the relief and treatment of underlying causes or secondary processes, and diagnosis and treatment of treatment side effects. Column 2, lines 25-46, identifies the steps of the '383 method. Those steps include (1) gathering demographic information for a patient and inputting the information into a computer, (2) gathering medical symptom information and inputting the patient's symptomology into the computer, (3) obtaining a pain score for the patient and inputting the pain score into the computer, (4) generating a treatment plan for the patient that includes, among other steps, the step of presenting the care provider at least one rule-based pain management algorithm, (5) permitting the care provider to adopt the treatment plan, (6) generating a prescription and related instructions and recording the adopted treatment plan and generated prescription information in the computer as a patient file. Column 3 discloses that the PMA system has three components, i.e., one for the primary care provider, one for the patient and one for the primary care provider to communicate electronically with pain specialists. As disclosed in Columns 5 and 6, after the patient's initial complaint is received, the PMA system presents rule-based pain management algorithms from which the primary care provider can select the most applicable pain management algorithm. After the pain management algorithm been selected, questions recorded in the PMA's rules of pain management algorithm are posed to the patient. The patient's responses are recorded in the patient's computer file for future reference; and based upon the patient's responses the PMA system will generate a prescription and a set of instructions for the patient. Brynjestad's '383 Pain Manager Advisor is directed toward the diagnosis and management of pain.

2) U.S. Pat. No. 5,839,438—Graettinger, et al. enables a neural network system and method for diagnosing patients' medical conditions to provide an efficient aid in identifying and interpreting factors which are significant in the medical diagnosis. The Graettinger neural network system uses input measurement and interview data to produce a graded classification of the patient's medical condition which is also accompanied by a diagnosis interpretation. The '438 system compares input values to assist the physician in making the diagnosis. In other words, the Graettinger system can provide a check for the physician regarding the physician's findings. Column 6, lines 4-11, discloses that the Graettinger method utilizes a scoring range of from zero to one to indicate the likelihood of disease. Column 6, lines 14-16, also teaches, “. . . the neural network 20 . . . is constructed by specifying the number, arrangement and connection of the processing elements which make up the network,” and column 7 indicates that the '438 method utilizes a data record for a multitude of patients. With respect how the neural network processes the data, column 9 teaches, “The preferred method of operation of the present invention comprises the steps of retrieving data, computing a diagnostic score, preparing a sorted list of contribution to the score, and displaying the results to a physician” And column 10 indicates how the diagnostic score is interpreted. The Graettinger invention is directed toward assisting the physician in making a diagnosis for the patient.

3) U.S. Pat. No. 5,954,641—Kehr, et al. sets forth a method, apparatus and operating system for managing the administration of medication and medical treatment regimens. The Kerr device stores medication schedules, treatment data, patient query data, and patient response data. FIGS. 2-15 and column 3 of the '641 Patent teach an electronic medication and medical treatment guide having a liquid crystal display as well as capacity for communicating with remote devices.

4) U.S. Pat. No. 6,584,445 B2—Papageorge discloses a computerized health evaluation system (CHES) that involves full patient participation in selecting various treatment options as well as a shared patient-physician decision making process regarding the possible treatments. Papageorge's computer system utilizes an algorithm for weighing both the patient's and physician's input which is stored in the '445 database. In essence, the CHES system is utilized to help the patient make an informed medical decision through full patient participation in selecting from various treatment options presented to the patient. Column 5 teaches of the benefits to insurers utilizing the CHES system, since insurers can review all possible treatment and cost options, thereby permitting reduction in overall costs. Columns 6 and 7 teach the patient is provided with an electronic platform explaining disease and treatment options. Thereafter, the patient responds to an electronic questionnaire and those responses are stored in the '445 database. Additionally, the physician is also provided with an electronic questionnaire different from the patient's electronic questionnaire. From the patient's and the physician's responses to the questionnaires, a CHES report is generated. The report is used by the patient and physician to jointly decide the optimal course of treatment for the patient.

5) U.S. Pat. No. 6,188,988 B1—Barry, et al. enables systems, methods and computer programs for guiding the physician in the selection of therapeutic treatment regimens. In particular, the '988 invention is directed toward methods and computer programs for guiding the physician in the selection of therapeutic treatments for cancer and HIV-1 infections. Column 2, lines 50-63, discloses the '988 method uses a plurality of knowledge bases, e.g., therapeutic treatment regimens, expert rules for selecting the treatment regimens, advisory information and patient's therapeutic history. Columns 4 and 5 disclose after the patient is examined by the physician, the patient's profile is thereafter entered in the appropriate knowledge base allowing the Barry method to generate from its expert rules a selection of treatment options and advisory information, such as drug interactions, contraindicated therapies or other warnings. The Barry invention is directed toward assisting the physician in establishing a therapy for the patient.

6) U.S. Pat. No. 6,177,940 B1—Bond, et al. enables an outcomes profile management system for evaluating treatment effectiveness. Column 2 teaches, “The present invention relates . . . to the field of menu-driven data entry and report generation systems which provide essentially real-time data analysis for comparing individual data points against a user-specified group to generate outcomes profile reports.” Column 3 teaches that patient data is collected from questionnaires presented to the patient on a data screen and column 17 discloses the medical staff selects the questions to be incorporated into the specific patient questionnaire. The patient answers the questions by using a touch screen. Thereafter, the patient's answers are transformed into quantitative values and statistically compared against group data. The '940 invention also mandates at least two separate questionnaires for the patient.

7) U.S. Pat. No. 6,302,833 B1—Walker, et al. enables a patient care delivery system. Column 2 teaches of a method of procuring a diagnosis which includes the steps of receiving data about at least one of the patient's physiological parameters, determining whether the received data is indicative of an anomaly, communicating the data to an expert and receiving from the expert a diagnosis. The Walker device is also a monitor capable of sending an alarm signal related to the patient's medical status to one or more hospitals.

8) US Published Patent Application 20010020229—Lash discloses a method and apparatus for determining high service utilization patients. Paragraph 11 of Lash reads, “In addition to apparatus, the present invention also provides a method of operating such apparatus for predicting the likelihood that a patient will acquire high service utilization characteristics. According to this method, a predictive model for predicting the likelihood that a patient will acquire high-use characteristics is developed by (i) selecting an initial set of potentially predictive patient claims variables suspected to have a potential effect on an outcome variable, the outcome variable corresponding to a high-use criterion during a targeted future time; (ii) conducting multivariate statistical regression modeling on the potentially predictive variables; (iii) evaluating the results of the analysis and eliminating the least predictive of the potentially predictive variables from the model; (iv) continuing the multivariate statistical regression modeling analysis and eliminating the next least predictive of the potentially predictive variables from the model; (v) repeating steps (ii) through (iv) until each of the remaining claims variables have a value greater that a predetermined threshold significance value; and (vi) basing the model on the remaining claims variables. Once the model is created, in the form of a probability equation, the variables for patients are input to the data processing system and analyzed according to the probability equation in the computer. This equation is based at least in part on the sum of each relevant claims variables multiplied by corresponding weighing coefficients for each. As a result, the stored program computes the probability values for each patient indicative of the likelihood that the patient will acquire high-use characteristics.” Among other things, the Lash method does not teach, suggest or disclose a representative of the care management entity personally contacting the potential patient to discern the potential patient's subjective cognition of the potential patient's living status and medical conditions where the representative can enter the representative's subjective assessment of the potential patient's subject responses into a computer system, or where the entry of the representative's subjective assessment of the potential patient's subjective responses into the computer system allows the care management entity to better determine which patient is more suitable for participation in the care management program.

9) US Published Patent Application 20030195772—Meek, et al. discloses a healthcare management system and method of predicting high utilizers of healthcare services. Paragraph 37 of Meek reads, “The exemplary HMS 100 is operable to display the health perception questionnaire on the video display 126 and receives responses to the questions of the questionnaire via the input device 128. Moreover, the exemplary HMS 100 is further operable to transmit the questionnaire to client computing devices 202₁, 202₂ . . . 202ₓ via the network 200, and receives responses to the questions of the questionnaire from client computing devices 202₁, 202₂ . . . 202ₓ via the network 200. The HMS 100 may also include various other mechanisms for receiving responses to the health perception questionnaire. For example, the HMS 100 may include a digital scanner that is operable to read from a printed questionnaire an individual's responses to the questions of the questionnaire. The HMS 100 may also obtain responses to the questionnaire from archived information stored on a removable medium 150, the mass storage device 124, or a database accessible via the network 200. Further yet, them HMS 100 may obtain responses to the questionnaire via telephone (e.g. an interactive voice response telephone system).” Among other things, the Lash method does not teach, suggest or disclose a representative of the care management entity personally contacting the potential patient to discern the potential patient's subjective cognition of the potential patient's living status and medical conditions where the representative can enter the representative's subjective assessment of the potential patient's subject responses into a computer system, or where the entry of the representative's subjective assessment of the potential patient's subjective responses into the computer system allows the care management entity to better determine which patient is more suitable for participation in the care management program.

### SUMMARY OF THE INVENTION

Traditional case management programs assist with the administration of the patient's treatment plan, and sometimes also generate a treatment plan for the patient. In an effort to look out for the patient's best interest, the case manager attempts to correlate all phases of the patient's treatment or treatment plans. Under the current system of care management of the ill population, it is not uncommon for the patient to have more than one care manager and/or healthcare provider involved with the patient's treatment plan. In other words, there can be overlap of services and wasted healthcare treatment capital.

The present method is related to care management of the treatment plan for co-morbid patients. High risk or co-morbid patients are a small percentage of the ill population requiring the greatest per capita expenditures of available healthcare capital. Typically, high risk patients are terminal and have one or more conditions effecting one or more organ systems. In short, co-morbid patients tend to be the sickest of the sick capable of living outside of a hospital or skilled nursing environment.

In an attempt to reduce the drain on available healthcare capital, the present criterion and method are particularly useful in selecting high risk patients for participation in care management. Before selection for participation in the care management program, the potential patient is accessed in view of the current computerized multi-component calculation. Based upon that assessment, a patient who has received an acuity score of thirty or greater is selected for participation in the care management system.

The current multi-component method includes components such as a medical diagnosis model or catalog, a cost factor categorization analysis and a questionnaire to elicit both subjective and objective responses from the potential high risk patient. Via telephony or in-person, an interviewer propounds the questionnaire's questions toward the potential patient. Responsive to the interrogation, the patient gives subject perceptions of his overall health, medical history, current medical state, nutritional requirements and motor skills as well as objective observations pertaining to medications, weight loss or gain, mobility, eyesight, breathing, smoking, alcohol consumption, trips to hospital emergency departments and family-caregiver relationships.

An aspect of the present invention is to provide a computerized method of selecting a high risk patient for participation in care management.

It is aspect of the present invention to provide a proprietary computer program and computer system for generating an acuity score.

Yet another aspect of the present invention is to reduce the amount of available healthcare capital expended in treating co-morbid patients.

Still another aspect of the present invention is to improve the quality of life for the high risk patients selected for participation in care management.

Yet still another aspect of the present invention is to provide a database for collecting mortality, morbidity and medical expenditure data for high risk medical conditions.

It is still another aspect of the present invention to provide a computer system and database for mining and collecting mortality, morbidity and medical expenditure data for high risk medical conditions from an entity such as state or national agencies, health maintenance organizations or insurance carriers.

Still another aspect of the present invention is to share the mortality, morbidity and medical expenditure data, without violating the patient's privacy rights, with entities other than the present method's owner.

An embodiment of the present invention can be described as a method for selecting a high risk patient for disease care management, comprising the steps of: verifying the patient's medical condition; assigning a predetermined numerical rating to the patient's medical condition; categorizing costs of the patient's medical treatment; assigning a predetermined numerical rating to the costs; interviewing the patient or the patient's representative to elicit responses; assigning a predetermined numerical rating to the responses; totaling the assigned numerical values; and selecting the patient for care management based upon the patient's medical acuity score.

Another embodiment of the present invention can be described a criterion for selecting a patient for high risk disease care management; the criterion comprising: a catalog of medical conditions, wherein each medical condition is assigned a predetermined numerical value and wherein the patient's diagnosis is compared against the catalog for generating a first element of an acuity score; a categorization of costs for the patient's medical care, wherein cost components of the categorization are assigned a predetermined numerical value for conversion into a second element of the acuity score; a list of interview questions to propound at the patient or the patient's representative via telephony for eliciting responses, wherein the responses are assigned a predetermined numerical value and quantified as a third element of the acuity score; and a summation of the first, the second and the third elements of the acuity score for determining whether the patient is selected for care management.

Yet another embodiment of the present invention can be described as a method for selecting a patient for high risk disease care management, comprising the steps of: monitoring medical care expenditure data associated with preselected medical conditions; monitoring mortality data for the preselected medical conditions; maintaining a data collection for the medical care expenditure data and the mortality data; verifying the high risk patient's medical condition with the patient's healthcare provider or said healthcare provider's agent; assigning a predetermined acuity rating to the high risk patient's medical condition; utilizing the data collection for categorizing costs of the high risk patient's medical treatment; assigning a predetermined acuity rating to the costs of the high risk patient's medical treatment; maintaining a list of interview questions for the high risk patients; electronically propounding the interview questions to the high risk patient or the patient's representative to elicit responses; assigning a predetermined acuity rating to the responses; generating a medical acuity score for the high risk patient from the assigned predetermined acuity ratings; and selecting the patient for care management based upon the patient's acuity score.

In still another embodiment, the present invention can be described as a method for selecting a patient for high risk disease care management, comprising the steps of: procuring mortality, morbidity and medical expenditure data for high risk medical conditions from an entity possessing said mortality, morbidity and medical expenditures; creating a database independent from the entity containing said mortality, morbidity and medical expenditure data for high risk medical conditions; utilizing a computer program and the database to generate a criterion for selecting a high risk patient for care management, wherein the criterion originates a computerized template for an interviewer identifying interview questions designed to elicit responses from a high risk patient or the high risk patient's representative; having an interviewer electronically propound interview questions at the high risk patient or the high risk patient's representative, thereafter incorporating the high risk patient or the high risk patient's representative's responses into the criterion; and utilizing the computer generated criterion for calculating an acuity score for the high risk patient, wherein the acuity score is determined from a composite of predetermined numerical values assigned to each element of the mortality, morbidity and medical expenditure data and the high risk patient's elicited responses.

It is the novel and unique interaction of these simple elements which creates the method and criterion, within the ambit of the present invention. Pursuant to Title 35 of the United States Code, descriptions of preferred embodiments follow. However, it is to be understood that the best mode descriptions do not limit the scope of the present invention.

### BRIEF DESCRIPTION OF THE DRAWINGS

FIG. 1 is a graphical representation comparing the co-morbid population with the total diseased or ill population.

FIG. 2 is a graphical representation of the costs attributed to the medical treatment of the high risk population and the costs attributed to the treatment of the remainder of the ill population.

FIGS. 3A and 3B depict a diagnoses model or catalog of medical conditions.

FIG. 4 exemplifies a cost factors component of the current method's acuity score.

FIGS. 5A and 5B depict a type of questionnaire utilized by an interviewer.

FIG. 6 portrays the care management entity's employee verifying the potential patient's medical condition.

FIG. 7 is another portrayal of the care management entity's employee verifying the potential patient's medical condition.

FIG. 8 is a representation of a computerized embodiment of the present method.

FIG. 9 is a representation of the current criterion's computer system communicating with other entity's computer systems.

### DESCRIPTION OF THE PREFERRED EMBODIMENTS

Although the disclosure hereof is detailed to enable those skilled in the art to practice the invention, the embodiments published herein merely exemplify the present invention.

In accordance with the current method, high risk patients with terminal or poor prognoses are selected for participation in a care management program. A computer system and proprietary computer program are utilized to select participants for the care management program. If a patient is selected for care management, a care manager, normally a nurse, assists with the administration of the treatment plan ordered by the patient's treatment plan originating health care professional.

Practice of the present method is designed to reduce the health care burden upon the general public by reducing the medical costs attributable to the medical treatment of high risk patients, also known as co-morbid patients. Because co-morbid patients require the highest degree of medical supervision and intervention, high risk patients consume the greatest per capita percentage of available private and public health care capital.

By way of illustration, high risk patients accepted for the current care management method include those patients having diseases or conditions effecting one or more of the body's major organ systems, e.g., brain, digestive system, heart, kidney, liver, lungs and/or skin, etcetera. There are a many chronic diseases or conditions, but a few well known examples of high risk diseases or conditions include alcoholism, Alzheimer's disease, AIDS, cancer, congestive heart failure, stroke, kidney failure and Parkinsonism. Frequently, patients selected for care management, by the present method, are those high risk patients having a terminal or poor prognosis. At the same time, depending upon the terminal progression of the selected patient's malady, care of a selected high risk patient accepted for care management can last for months or years.

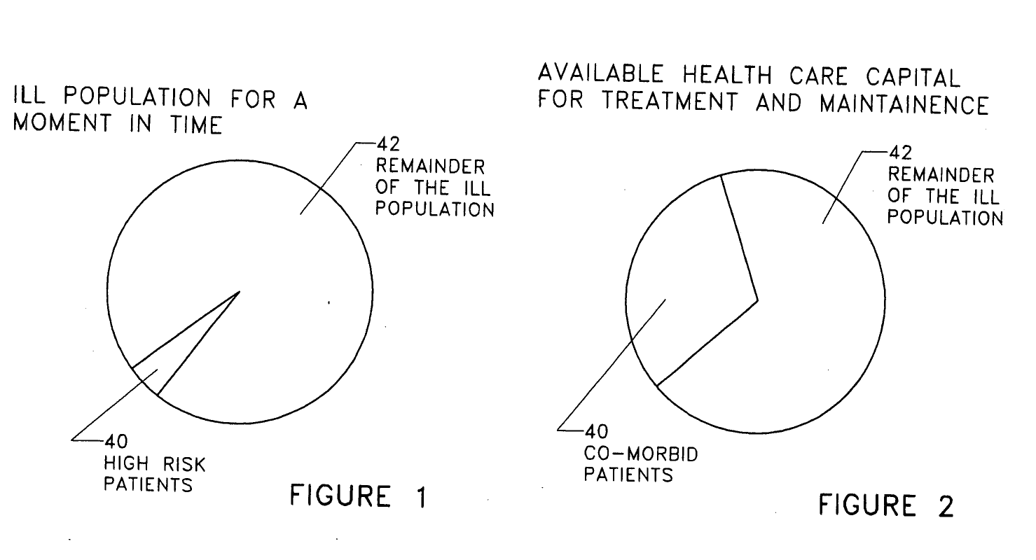

FIG. 1 is a graphical representation comparing the co-morbid population (40) with the total diseased or ill population (42). As shown, for any statistical moment in time, the high risk population (50) is a small percentage of the total diseased population (42). FIG. 2 is a graphical representation of the costs attributed to the medical treatment of the high risk population (40) and the costs attributed to the treatment of the remainder of the ill population. Side-by-side comparison of FIGS. 1 and 2 reveal co-morbid patients require a disproportionate share of available health care capital. By the practicing the present method, it is anticipated the disproportionate share of available public and private health care capital expended on the treatment of high risk patients can be reduced.

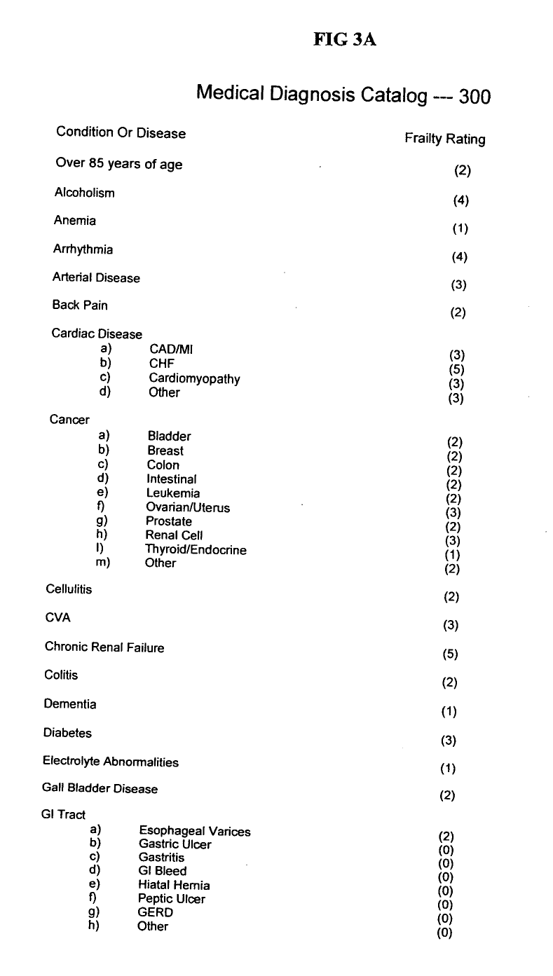

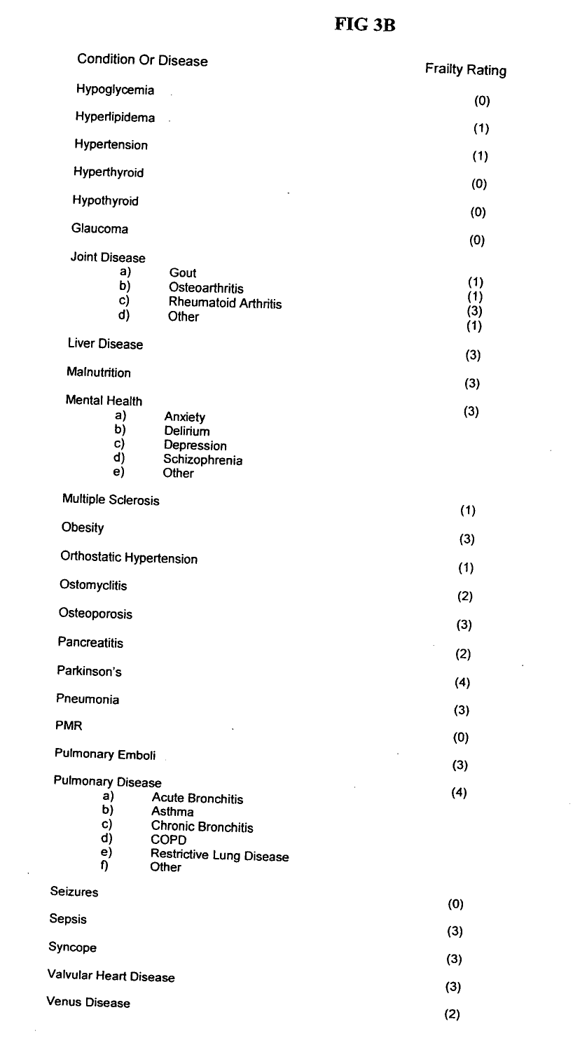

FIGS. 3A and 3B depict a diagnoses model or catalog (300) of medical conditions. However, those skilled in the art recognize other catalogs or models including other diseases are also within the scope of the present method. As shown in FIGS. 3A and 3B, predetermined numerical values are associated with the numerous disease or condition states of the ill population. By way of illustration, back pain has an acuity rating of (2), gall bladder disease has an acuity rating of (2), and hypothyroidism has an acuity rating of (0). In accordance with the current method, the summation of predetermined acuity ratings associated with the high risk patient's medical conditions is a component of the patient's multi-component acuity score.

When practicing select embodiments of the present method, catalog's (300) predetermined acuity ratings are pre-weighted by a care management entity's employee. For example, in a hard copy embodiment of the current method, a physician experienced in caring for the terminally co-morbid population can assign the predetermined acuity values or ratings for each disease of medical condition. In other embodiments, the numerical values utilized in calculating the acuity score for a high risk patient are assigned and weighted by a proprietary computer program. Over a period of time, as data is gathered, the computer program can modify the predetermined acuity ratings in accordance with a predetermined paradigm.

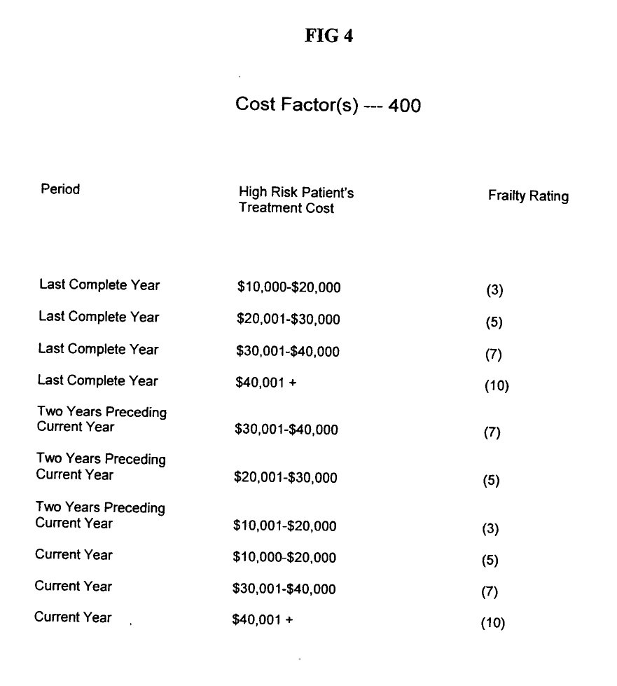

FIG. 4 exemplifies a cost factors (400) component of the current method's acuity score. As shown, the predetermined acuity values or ratings have been weighted according to the annualized costs for the medical treatment of co-morbid patients. By way of example, for the annualized period of two years prior to the current year, if the high risk patient's treatment costs were between $30,001 and $40,000, then an acuity rating of (7) is assigned to such expenditures. Similarly, if the high risk's patient current annualized treatment costs are between $20,001 and $30,000, an acuity rating of (5) is assigned to those expenses. Treatment costs can be defined as the total costs of care for the patient for a given period. For example, a patient's annualized treatment costs can be a function of calendar years or the annualized treatment costs can be any predetermined twelve-month period, i.e., the twelve-month period is predetermined by a governmental agency, health maintenance organization or health care provider, etc.

When practicing select embodiments of the present method, the cost factors' (400) predetermined acuity values displayed in FIG. 4 are pre-weighted by a care management entity's employee. This employee can be one experienced in ascertaining the true costs of medical treatments as a function of a specific geographic region, e.g., an individual familiar with Medicare and Medicaid costs for a particular state. In other embodiments, the acuity ratings attributed to the annualized costs of medical treatment of a patient are assigned and weighted by a computer program. Annualized medical costs for up to three years can be utilized in calculating the annualized medical treatment cost acuity rating component of the multi-component acuity score. Of course, over time, as patient treatment data is accumulated in the care management entity's database, the present method's computer program can modify the numerical acuity ratings in accordance with a predetermined paradigm. Such a predetermined paradigm can be grounded in the statistical significance of medical treatment costs of the high risk patient population. In select embodiments, the annualized medical treatment cost acuity rating component does not exceed a fixed limit established by the care management entity—thereby preventing an overweighting of the annualized medical treatment cost acuity rating component of the current multi-component acuity score of a high risk patient.

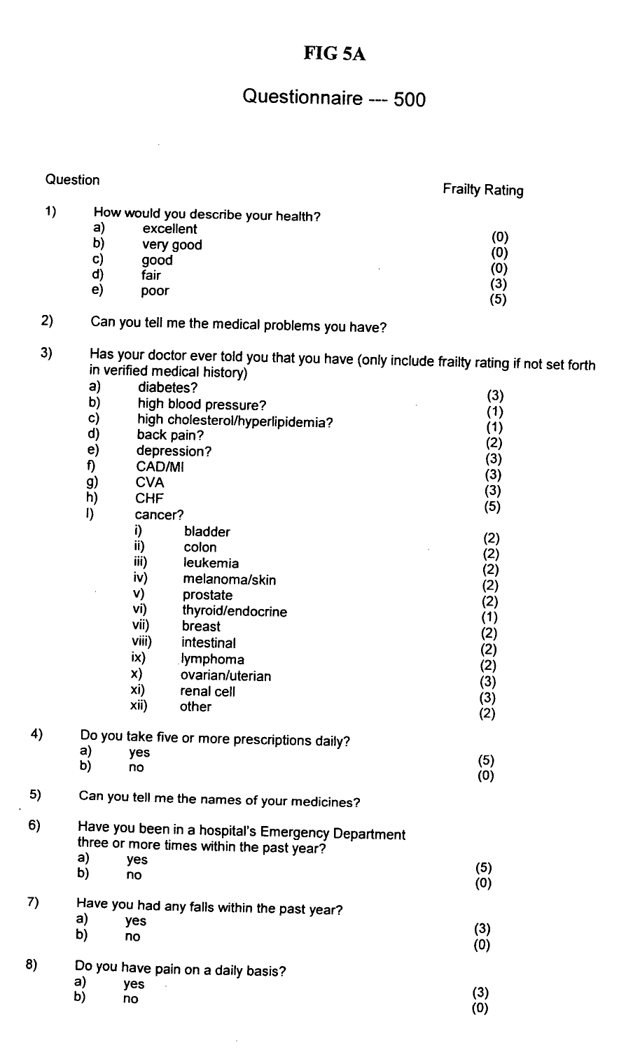

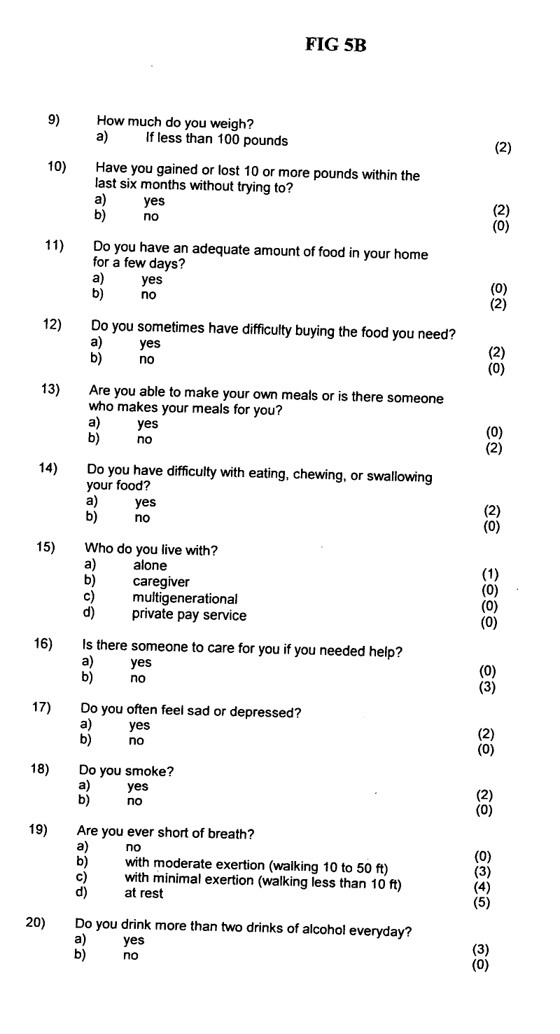

FIG. 5 is a type of questionnaire (500) that can be utilized by an interviewer employed by the care management entity when conducting a telephonic or in-person interview with high risk patient (44) or patient's representative (46). As used herein, a patient's representative is considered to be one having legal authority to act on behalf of the high risk patient. A telephonic interview conducted by interviewer (50) can be another part of the current method, and frequently, in the practice of the present method, interviewer (50) is a nurse. In one embodiment, the questionnaire (500) can be a hard copy paper-type document, while in another embodiment, the questionnaire can be an electronic template (500) generated by a proprietary computer program associated with the care management entity's computer system capable of generating real time analysis of the patient's (44) acuity ratings and acuity score.

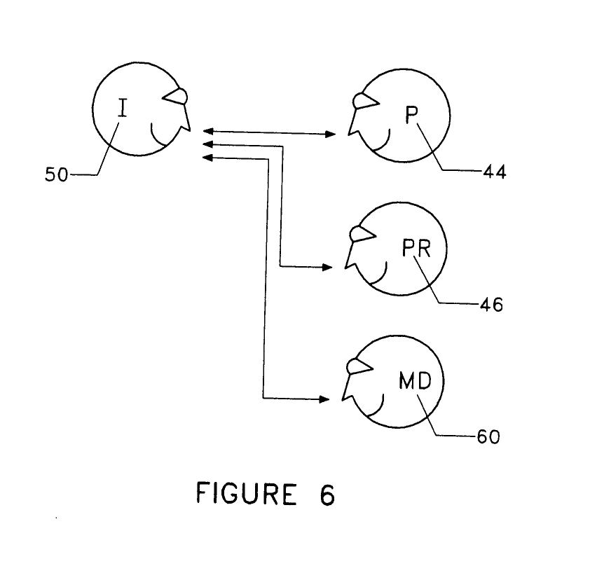

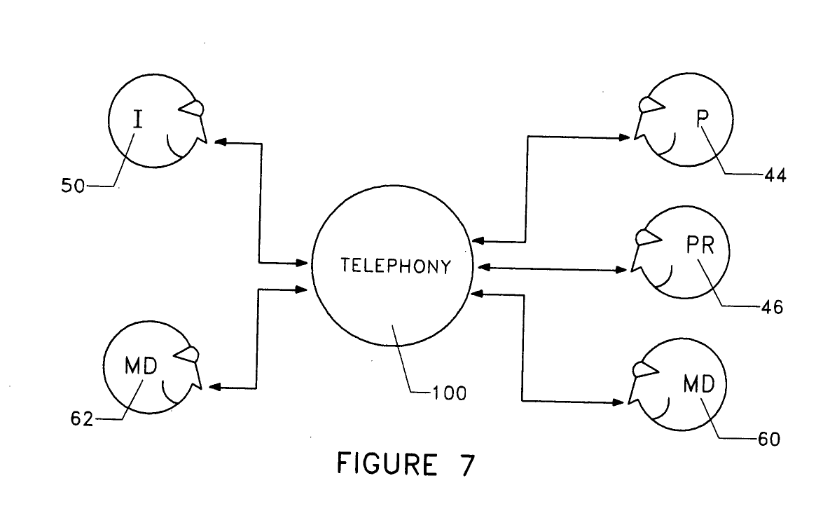

With a view toward FIG. 6, in one embodiment of the current method, before patient (44) is accepted into the care management program, care management entity's employee (50) will verify the medical condition of the potential patient with either the patient (44), the patient's representative (46) and/or the patient's treatment plan health care provider (60), e.g., the patient's primary physician. As shown in FIG. 6, it is possible for potential patient (44) or patient's representative (46), interviewer (50) and physician (60) to interact face-to-face. However, as shown in FIG. 7, more frequently, interviewer (50), potential patient (44) or patient's representative (46), physician (60) and physician (62) will communicate via public telephony (100). For some high risk patients, before accepting the patients for care management, it may be necessary to verify the patient's diagnosis from a plurality of health care providers.

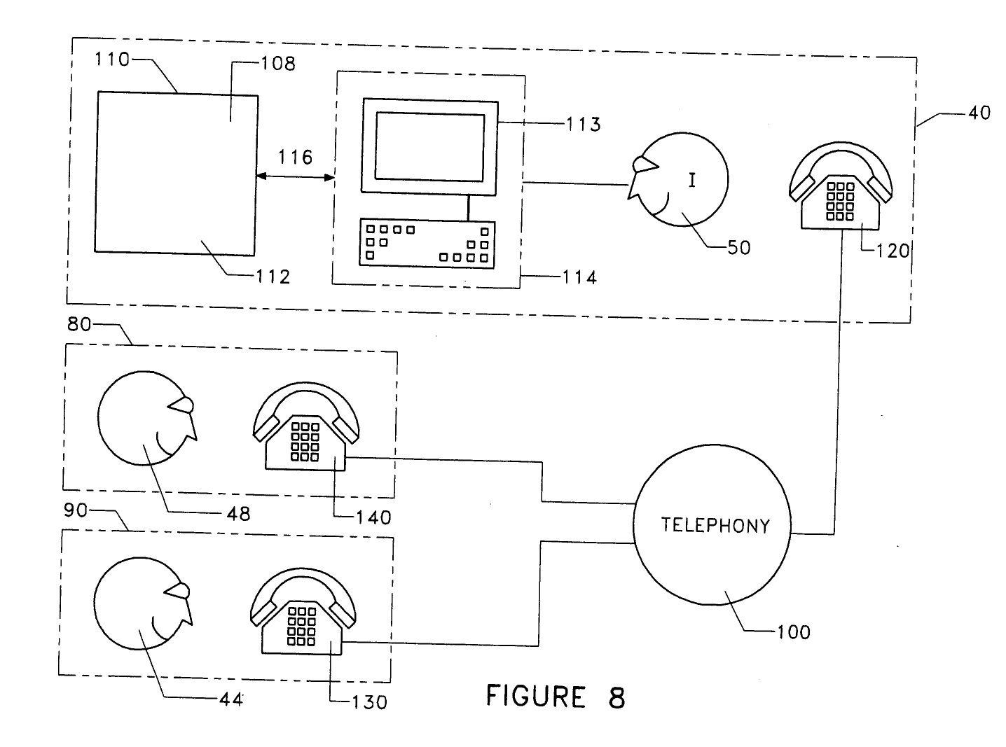

FIG. 8 is a representation of a computerized embodiment of the present method. Care management entity's (40) computer system (110) including proprietary computer program (112) is connected to interviewer's (50) terminal (114) via any manner acceptable in the art connection (116). Within the scope of the present method, the care management entity can be a corporation, association, partnership, sole proprietorship, or any other legal entity that is not responsible for establishing or originating the treatment plan or plans for the high risk patient. If the high risk patient is eventually selected for participation in current method, the care management entity (40) only supplements or assists in the administration of the high risk patient's treatment plan and is not responsible for establishing the diagnosis or treatment plan for the high risk patient.

Returning to FIG. 8, entity's (40) computer system may or may not be at location remote from interviewer (50) and terminal (114). As shown, interviewer (50) is conducting a simultaneous interview with patient (44) at location (90) via phone (130) and patient (48) at location (80) via phone (140). In other embodiments, there may be more than one interviewer or one interviewer may only conduct a single interview at a time. Interviewer (50) communicates with patient (48) via public telephony (100) and telephones (120) and (140), and interviewer (50) communicates with patient (44) through public telephony and phones (120) and (130). Within the scope of the current method, interviews may be conducted via cellular or land lines or any combination thereof or in-person.

In practicing one embodiment of the current method, interviewer (50) will propound questions from questionnaire (500) toward patients (44) and (48). With reference to FIG. 5, examples of questions from questionnaire (500) include:
a) How would you describe your health at the present time?
b) Has your doctor every told you that you have diabetes?
c) Have you been to the Emergency Department three or more times within the past year?
d) Have you gained or lost 10 more pounds in the last six months without trying to?
e) Do you have difficulty with your eyesight?
f) Do you often feel sad or depressed?

The co-morbid patients (44, 48) responses to interviewer's (50) questions from questionnaire (500) are entered into computer program (112) of computer system (110) at terminal (114). Along with entering patients (44, 48) responses into database (108) of computer system (110), computer program (112) will correlate the patients' responses with specific predetermined acuity ratings to generate components of the patients' (44, 48) acuity scores.

By way of illustration, when practicing the current method, interviewer (50) ascertains patent's (44) subjective responses regarding patient's (44) daily living status and medical conditions. To better determine which patient is suitable for participation in the care management program, interviewer (50) subjectively evaluates patient's (44) responses. It is believed that interviewer's (50) subjective evaluation of patient's (44) subjective responses reduces incorrect responses contributing to erroneous acuity score calculations. When interviewer's (50) evaluation of patient's (44) living status and medical conditions differs from patient's (44) subjective responses, interviewer's (50) entry of an evaluated response into questionnaire (500) alters the predetermined significance of patient's (44) subjective response associated with patient's (44) subjective acuity rating component of patient's (44) acuity score. Practice of the current method utilizing the interviewer's subjective evaluations of the patients' subjective responses to questionnaire (500) allows the care management entity to determine which patients are better suited for participation in the care management program.

Within the ambit of the present method, it has unexpectedly been determined that high risk patients receiving an acuity score of 30 or greater are the patients most suitable for selection to participate in the care management program. The current method meets the long desired but unmet need of providing a method for selection of the sickest of the sick for care management while excluding those patients existing in lesser morbidity states. It is believed the practice of the present method can reduce the drain on available health care capital by selectively utilizing a care manager to assist in the administration of the patient's treatment plan only when the use of a care manager is cost efficient. By way of illustration, the proprietary computer program's weighting of the objective acuity rating component, the annualized medical treatment cost acuity rating component and the subjective acuity rating component prevents the heavy reliance on hospitalization costs associated with the prior art that can lead to the patient's participation in the health management program where the health management program is incapable of reducing the treatment costs of the patient.

As depicted in FIGS. 5 and 8, computer system's (110) questionnaire (500) is visualized as template (113) on terminal (114). Questionnaire's (500) questions are designed to elicit both subjective and objective perceptions from the high risk patient. By way of example, the co-morbid patient or the patient's representative will relate subject observations regarding the high risk patient's overall health, medical history, current medical state, nutritional requirements and motor skill as well as the patient's objective comments related to medications, weight loss or gain, mobility, eyesight, breathing, smoking habits, alcohol consumption, trips to hospital emergency departments and family-caregiver relationships.

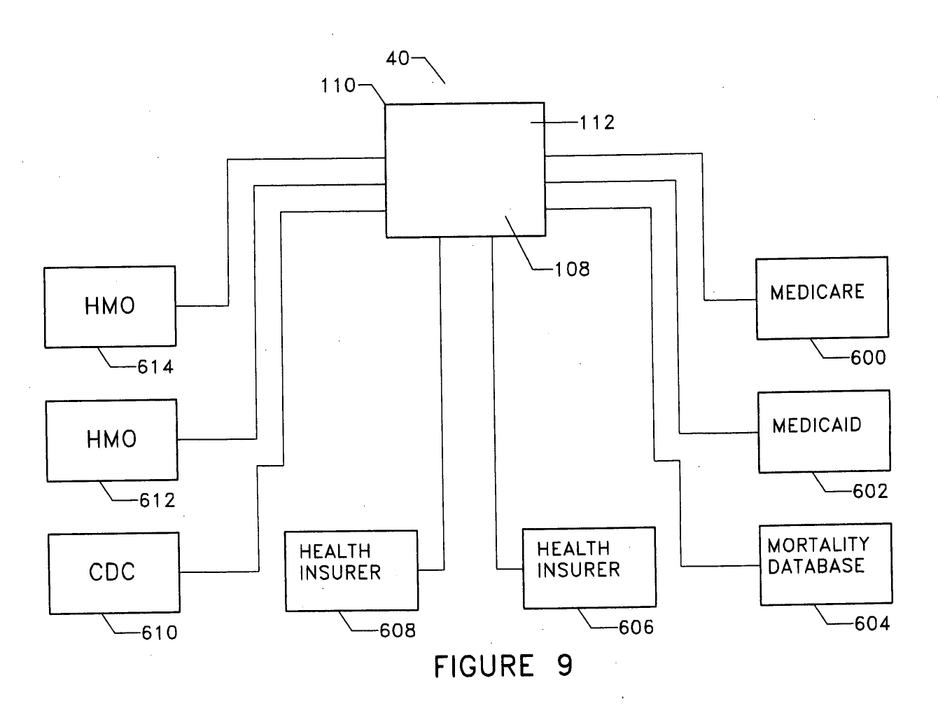

With a view toward FIG. 9, by way of illustration, and via any manner acceptable in the art, entity's (40) computer system (110) and database (108) can communicate with Medicare database (600), Medicaid database (602), mortality database (604), first health insurer database (606), second health insurer database (608), Center for Disease Control database (610), first health maintenance organization's (612) database and second health maintenance organization (614) database. Database (108) can also communicate with institutions other than those indicated above, or with one or more of the identified institutions rather all those indicated above. In short, database (108) can monitor mortality data, morbidity data and medical care or treatment expenditures, tracked by institutions other than entity (40), for patients having certain medical conditions. The data obtained by entity (40), in combination with computer program (112), can be used to update predetermined acuity ratings associated with the cataloged medical conditions and/or the acuity values for medical treatment costs associated with the cataloged medical conditions.

Having disclosed the various components of the current criterion and methodology for selecting high risk patients for care management, some examples of the types of patients selected or rejected for care management are set forth below. It is to be understood examples 1-5 are merely representative of the current method and do not limit the scope of the present method. In other words, there are a plethora of variables to be analyzed in determining whether or not to accept a co-morbid patient for care management.

### EXAMPLE 1

### Patient A

An interviewer has verified from the required sources the potential patient:
a) Was hospitalized one time during the preceding year—Acuity Rating (0);
b) Is over 85 years of age—Acuity Rating (2);
c) Has a diagnosis of diabetes—Acuity rating (3);
d) That treatment costs for the previous year were $15,500—Acuity Rating (3); and
e) That treatment costs for the current year are less than $5,000—Acuity Rating (0).

During the telephonic interview, the potential patient A responds to questionnaire (500) as follows:

| | | | Acuity Rating |
|---|---|---|---|
| 1) | How would you describe your health? | Good | (0) |
| 2) | Can you tell me the medical problems you have? | Sugar | |
| 3) | Has your doctor ever told you that you have diabetes? | Yes | (0) |
| 4) | Do you take five or more prescriptions daily? | No | (0) |
| 5) | Can you tell me the names of your medicines? | Insulin | |
| | | Aspirin | |
| 6) | Have you been in a hospital's Emergency Department | No | (0) |
| | three or more times within the past year? | | |
| 7) | Have you had any falls within the past year? | No | (0) |
| 8) | Do you have pain on a daily basis? | Yes | (3) |
| 9) | How much do you weigh? | 210 | (0) |
| 10) | Have you gained or lost 10 or more pounds within the | Yes | (2) |
| | last six months without trying to? | | |
| 11) | Do you have an adequate amount of food in your home | Yes | (0) |
| | for a few days? | | |
| 12) | Do you sometimes have difficulty buying the food you | No | (0) |
| | need? | | |
| 13) | Are you able to make your own meals or is there | Yes | (0) |
| | someone who makes your meals for you? | | |
| 14) | Do you have difficulty with eating, chewing, or | No | (0) |
| | swallowing your food? | | |
| 15) | Who do you live with? | Alone | (1) |
| 16) | Is there someone to care for you if you needed help? | No | (3) |
| 17) | Do you often feel sad or depressed? | Yes | (2) |
| 18) | Do you smoke? | No | (0) |
| 19) | Are you ever short of breath? | No | (0) |
| 20) | Do you drink more than two drinks of alcohol everyday? | No | (0) |

| | | |
|---|---|---|
| Questionnaire Summation Acuity Rating Total | — | 11 |
| Catalog And Cost Summation Acuity Rating Total | — | 8 |
| Acuity Score | | 19 |

Since Patient A's acuity score is less than 30, Patient A would not be selected for participation in the care management program.

### EXAMPLE 2

### Patient B

An interviewer has verified from the required sources the potential patient:
a) Was admitted to emergency department four times during the preceding year—Acuity Rating (5);
b) Has a diagnosis of congestive heart failure and osteoporosis—Acuity Rating (8);
c) That treatment costs for the previous year were $37,500—Acuity Rating (7); and

d) That treatment costs for the current year are $10,500—Acuity Rating (5).

During the telephonic interview, the potential patient B responds to questionnaire (500) as follows:

| | | | Acuity Rating |
|---|---|---|---|
| 1) | How would you describe your health? | Fair | (3) |
| 2) | Can you tell me the medical problems you have? | Heart and brittle | |
| | | bones | |
| 3) | Has your doctor ever told you that you have | Yes | (5) |
| | heart problems? | | |
| 4) | Do you take five or more prescriptions daily? | Yes | (5) |
| 5) | Can you tell me the names of your medicines? | Little heart pill | |
| | | Big heart pill | |
| | | Oblong heart pill | |
| | | Bone pill | |
| | | Laxative pill | |
| | | Little orange pill | |
| 6) | Have you been in a hospital's Emergency Department | Yes | Verified above |
| | three or more times within the past year? | | |
| 7) | Have you had any falls within the past year? | No | (0) |
| 8) | Do you have pain on a daily basis? | No | (0) |
| 9) | How much do you weigh? | 95 | (2) |
| 10) | Have you gained or lost 10 or more pounds within the | No | (0) |
| | last six months without trying to? | | |
| 11) | Do you have an adequate amount of food in your home | Yes | (0) |
| | for a few days? | | |
| 12) | Do you sometimes have difficulty buying the food you | No | (0) |
| | need? | | |
| 13) | Are you able to make your own meals or is there | Yes | (0) |
| | someone who makes your meals for you? | | |
| 14) | Do you have difficulty with eating, chewing, or | No | (0) |
| | swallowing your food? | | |
| 15) | Who do you live with? | A woman stays | (0) |
| | | with me | |
| 16) | Is there someone to care for you if you needed help? | Yes | (0) |
| 17) | Do you often feel sad or depressed? | Yes | (2) |
| 18) | Do you smoke? | No | (0) |
| 19) | Are you ever short of breath? | Sometimes when | (3) |
| | | walking a few steps | |
| 20) | Do you drink more than two drinks of alcohol everyday? | No | (0) |

| | | |
|---|---|---|
| Questionnaire Summation Acuity Rating Total | — | 20 |
| Catalog And Cost Summation Acuity Rating Total | — | 20 |
| Acuity Score | | 45 |

Since Patient B's acuity score is greater than 30, Patient B would be selected for participation in the care management program.

### EXAMPLE 3

### Patient C

An interviewer has verified from the required sources the potential patient:
a) Was hospitalized twice during the two years preceding the current year—Acuity Rating (0);
b) Is under 85 years of age—Acuity Rating (0);
c) Has a diagnosis of emphysema—Acuity Rating (4);
d) That treatment costs for the two years preceding the current year were $27,000—Acuity Rating (3);
e) That treatment costs for the year preceding the current year were $12,900—Acuity Rating (3)
f) That treatment costs for the current year are $10,800—Acuity Rating (3).

During the telephonic interview, the potential patient C responds to questionnaire (500) as follows:

| | | | Acuity Rating |
|---|---|---|---|
| 1) | How would you describe your health? | Fair | (3) |
| 2) | Can you tell me the medical problems you have? | Diagnosed with | |
| | | Emphysema | |
| 3) | Has your doctor ever told you that you have ( )? | Not Applicable | (0) |
| 4) | Do you take five or more prescriptions daily? | No | (0) |
| 5) | Can you tell me the names of your medicines? | Fluid pill | |
| | | Sleeping pill | |
| | | Aerosol breathing | |
| | | machine | |
| | | Oxygen | |
| 6) | Have you been in a hospital's Emergency Department | No | (0) |
| | three or more times within the past year? | | |
| 7) | Have you had any falls within the past year? | Yes | (3) |
| 8) | Do you have pain on a daily basis? | Yes | (3) |
| 9) | How much do you weigh? | 165 | (0) |
| 10) | Have you gained or lost 10 or more pounds within the | No | (0) |
| | last six months without trying to? | | |
| 11) | Do you have an adequate amount of food in your home | Yes | (0) |
| | for a few days? | | |
| 12) | Do you sometimes have difficulty buying the food you | Yes | (2) |
| | need? | | |
| 13) | Are you able to make your own meals or is there | Yes | (0) |
| | someone who makes your meals for you? | | |
| 14) | Do you have difficulty with eating, chewing, or | No | (0) |
| | swallowing your food? | | |
| 15) | Who do you live with? | Alone | (1) |
| 16) | Is there someone to care for you if you needed help? | Yes | (0) |
| 17) | Do you often feel sad or depressed? | Yes | (2) |
| 18) | Do you smoke? | Yes | (4) |
| 19) | Are you ever short of breath? | Hard to walk across | (4) |
| | | the room at times | |
| 20) | Do you drink more than two drinks of alcohol everyday? | Yes | (3) |

| | | |
|---|---|---|
| Questionnaire Summation Acuity Rating Total | — | 10 |
| Catalog And Cost Summation Acuity Rating Total | — | 25 |
| Acuity Score | | 35 |

Since Patient C's acuity score is greater than 30, Patient C would be selected for participation in the care management program.

### EXAMPLE 4

### Patient D

An interviewer has verified from the required sources the potential patient:
a) Was hospitalized twice during current year—Acuity Rating (0);
b) Is under 85 years of age—Acuity Rating (0);
c) Has a diagnosis of ovarian and bladder cancer—Acuity Rating (5);
e) That treatment costs for the year preceding the current year were $1,000—Acuity Rating (0)
f) That current year's treatment costs are $19,300—Acuity Rating (5).

During the telephonic interview, the potential patient D responds to questionnaire (500) as follows:

| | | | |
|---|---|---|---|
| 1) | How would you describe your health? | Under the circumstances, | (0) |
| | | very good | |
| 2) | Can you tell me the medical problems you have? | Cancer | |
| 3) | Has your doctor ever told you that you have cancer? | Yes, ovarian, bladder | (5) |
| 4) | Do you take five or more prescriptions daily? | Yes | (5) |
| 5) | Can you tell me the names of your medicines? | I just know most of | |
| | | them are anticancer | |
| | | drugs. Oh yes, and | |
| | | there are the antinauseants | |
| 6) | Have you been in a hospital's Emergency Department | No | (0) |
| | three or more times within the past year? | | |
| 7) | Have you had any falls within the past year? | No | (0) |
| 8) | Do you have pain on a daily basis? | No | (0) |
| 9) | How much do you weigh? | 132 | (0) |
| 10) | Have you gained or lost 10 or more pounds within the | Yes | (2) |
| | last six months without trying to? | | |
| 11) | Do you have an adequate amount of food in your home | Yes | (0) |
| | for a few days? | | |
| 12) | Do you sometimes have difficulty buying the food you | No | (0) |
| | need? | | |
| 13) | Are you able to make your own meals or is there | Yes | (0) |
| | someone who makes your meals for you? | | |
| 14) | Do you have difficulty with eating, chewing, or | Yes | (2) |
| | swallowing your food? | | |
| 15) | Who do you live with? | Husband | (0) |
| 16) | Is there someone to care for you if you needed help? | Yes | (0) |
| 17) | Do you often feel sad or depressed? | Yes | (2) |
| 18) | Do you smoke? | No | (0) |
| 19) | Are you ever short of breath? | No | (0) |
| 20) | Do you drink more than two drinks of alcohol everyday? | No | (0) |

| | | |
|---|---|---|
| Questionnaire Summation Acuity Rating Total | — | 16 |
| Catalog And Cost Summation Acuity Rating Total | — | 10 |
| Acuity Score | | 26 |

Since Patient D's acuity score is less than 30, Patient D would not be selected as a candidate for participation in the care management program.

### EXAMPLE 5

### Patient E

An interviewer has verified from the required sources the potential patient:
a) Was hospitalized twice during current year—Acuity Rating (0);
b) Is over 85 years of age—Acuity Rating (2);
c) Has a diagnosis of Parkinson's Disease—Acuity Rating (4);
e) That treatment costs for the year preceding the current year were $26,500 —Acuity Rating (5)
f) That current year's treatment costs are $19,300—Acuity Rating (5).

During the telephonic interview, the potential patient E responds to questionnaire (500) as follows:

| | | | |
|---|---|---|---|
| 1) | How would you describe your health? | Good | (0) |
| 2) | Can you tell me the medical problems you have? | Parkinson's | |
| 3) | Has your doctor ever told you that you have ( )? | Not Applicable | (0) |
| 4) | Do you take five or more prescriptions daily? | I don't think so | (0) |
| 5) | Can you tell me the names of your medicines? | I can't | |
| | | remember | |
| 6) | Have you been in a hospital's Emergency Department | Yes | (5) |
| | three or more times within the past year? | | |
| 7) | Have you had any falls within the past year? | Yes | (3) |
| 8) | Do you have pain on a daily basis? | No | (0) |
| 9) | How much do you weigh? | 163 | (0) |
| 10) | Have you gained or lost 10 or more pounds within the | No | (0) |
| | last six months without trying to? | | |
| 11) | Do you have an adequate amount of food in your home | Yes | (0) |
| | for a few days? | | |
| 12) | Do you sometimes have difficulty buying the food you | No | (0) |
| | need? | | |
| 13) | Are you able to make your own meals or is there | Yes | (0) |
| | someone who makes your meals for you? | | |
| 14) | Do you have difficulty with eating, chewing, or | Yes | (2) |
| | swallowing your food? | | |
| 15) | Who do you live with? | My daughter and | (0) |
| | | her husband | |
| 16) | Is there someone to care for you if you needed help? | Yes | (0) |
| 17) | Do you often feel sad or depressed? | No | (0) |
| 18) | Do you smoke? | No | (0) |
| 19) | Are you ever short of breath? | No | (0) |
| 20) | Do you drink more than two drinks of alcohol everyday? | No | (0) |

| | | |
|---|---|---|
| Questionnaire Summation Acuity Rating Total | — | 16 |
| Catalog And Cost Summation Acuity Rating Total | — | 10 |
| Acuity Score | | 26 |

Since Patient E's acuity score is less than 30, Patient E would not be selected as a candidate for participation in the care management program.

As previously indicated, the above identified examples are set forth merely to exemplify the practice of the present criterion and method. The number of variables affecting whether or not a particular patient receives an acuity score of 30 or greater and is accepted for participation in the care management program is virtually unlimited. And as demonstrated in the above examples, some patients, although considered terminal, are deemed too healthy for participation in the care management program.

Having disclosed the invention as required by Title 35 of the United States Code, Applicants now pray respectfully that Letters Patent be granted for their invention in accordance with the scope of the claims appended hereto.

What is claimed is:

1) A method for selecting a high risk patient for participation in a care management program for patients having poor prognoses, wherein said care management program is provided by a care management entity not responsible for said high risk patient's diagnosis or prescribed medical treatment, wherein selection of said high risk patient for participation in said care management program is determined by said high risk patient's acuity score, wherein said acuity score is calculated by said care management entity's computer system utilizing a proprietary computer program capable of generating data enterable and viewable electronic templates for use with a multi-component calculation of said acuity score, and wherein said acuity score comprises:
i) an objective acuity rating component based on a care management entity's representative's verification of a potential patient's current and past medical conditions with one or more of said potential patient, said potential patient's representative or said potential patient's treatment plan health care provider, wherein each medical condition is assigned a predetermined numerical value established by said care management entity, and wherein said objective acuity rating component is a summation of said predetermined numerical values;
ii) an annualized medical treatment cost acuity rating component based on said care management entity's representative's verification of said potential patient's prior annualized treatment costs for up to three preceding years, wherein each yearly cost of treatment of said prior annualized treatment costs has a specific acuity rating assigned by said care management entity, wherein said annualized medical treatment cost acuity rating component is a summation of said specific acuity ratings, and wherein, by predefined parameters implemented by said proprietary program, said summation of said specific acuity ratings does not exceed a fixed limit established by said care management entity; and
iii) a subjective acuity rating component, wherein subjective responses from said potential patient regarding said patient's cognition of said potential patient's daily living status and medical conditions are solicited by said care management entity's representative, wherein each of said potential patient's responses has a predetermined numerical significance assigned by said care management entity, and wherein said subjective acuity rating component is a summation of said predetermined numerical significances;
said method for selecting said high risk patient for participation in said care management program for patients having poor prognoses, comprising the steps of:
a) having said care management entity's representative enter said potential patient's verified current and past medical conditions into an objective acuity rating component electronic template viewable on said computer system and authorizing said computer system to calculate said objective acuity rating component;
b) having said care management entity's representative enter said potential patient's verified prior annualized treatment costs into an annualized medical treatment cost acuity rating electronic template and authorizing said computer system to calculate said annualized medical treatment cost acuity rating component;
c) having said computer system generate an electronic questionnaire for utilization by said care management entity's representative in conducting a remote telephonic or an in-personal interview of said potential patient to solicit said subjective responses from said potential patient regarding said patient's cognition of said potential patient's daily living status and medical conditions, wherein said care management entity's representative subjectively evaluates said potential patient's subjective responses in conjunction with entering said potential patient's evaluated responses into said electronic questionnaire, wherein said care management entity's representative's subjective evaluation of said potential patient's subjective responses and subsequent entry of said evaluated responses into said electronic questionnaire can alter said predetermined significance of any said potential patient's subjective responses allowing said care management entity to better determine which potential patient is more suitable for management by said care management program;
d) having said computer system calculate said subjective acuity rating component,
e) having said computer program weigh said objective acuity rating component, said annualized medical treatment cost acuity rating component and said subjective acuity rating component according to parameters assigned by said care management entity; and
f) having said computer system calculate said high risk patient's acuity score from said weighted objective acuity rating component, said weighted annualized medical treatment cost acuity rating component and said weighted subjective acuity rating component, wherein, as a result of said high risk patient's acuity score, said high risk patient is accepted or rejected for participation in said care management program.

2) The method of claim 1 further comprising the steps of:
a) having said care management entity's computer system mine third party databases for mortality, morbidity, medical care and treatment expenditure data associated with high risk patients other than patients managed by said care management entity; and
b) utilizing said computer program to analyze said mined data according to parameters assigned by said care management entity.

3) The method of claim 2 further comprising the step of utilizing a compilation of said analyzed mined data and data stored in said care management entity's computer system for modifying weighting of said objective acuity rating component, said annualized medical treatment cost acuity rating component and said subjective acuity rating component.

4) The method of claim 3, wherein said care management entity's computer system mines one or more of Medicare, Medicaid, mortality, health insurers, Center for Disease Control and health maintenance organization databases.

5) A method for selecting a high risk patient for participation in a care management program for patients having poor prognoses, wherein said care management program is provided by a care management entity not responsible for said high risk patient's diagnosis or prescribed medical treatment, wherein selection of said high risk patient for participation in said care management program is determined by said high risk patient's acuity score, wherein said acuity score is calculated by said care management entity's computer system utilizing a proprietary computer program capable of generating data enterable and viewable electronic templates for use with a multi-component calculation of said acuity score; said method for selecting a high risk patient comprising the steps of:
a) having a representative of said care management entity verify current and past medical conditions for a potential patient of said care management program;
b) having said representative enter said potential patient's verified current and past medical conditions into an objective acuity rating component electronic template of said multi-component calculation;
c) having said computer system calculate said objective acuity rating component, wherein said objective acuity rating component is a summation of assigned values for each medical condition, and wherein said values are assigned by said proprietary computer program;
d) having said representative verify prior annualized treatment costs of said potential patient;
e) having said representative enter said potential patient's verified prior annualized treatment costs into an annualized medical treatment cost acuity rating electronic template of said multi-component calculation;
f) having said computer system calculate said annualized medical treatment cost acuity rating component, wherein said annualized medical treatment cost acuity rating component is a summation of assigned specific acuity ratings associated with each yearly cost of treatment for as many as three preceding years, wherein said specific acuity ratings are assigned by said proprietary computer program, and wherein, by predefined parameters implemented by said proprietary program, said summation of said specific acuity ratings does not exceed a fixed limit established by said care management entity;
g) having said computer system generate an electronic questionnaire, associated with a subjective acuity rating component of said multi-component calculation, for utilization by said representative in conducting a remote telephonic or in-person interview of said potential patient to solicit subjective responses from said potential patient regarding said potential patient's cognition of said potential patient's daily living status and medical conditions, wherein each of said potential patient's responses has a predetermined numerical significance assigned by said proprietary computer program, and wherein said subjective acuity rating component is a summation of said predetermined numerical significances;
h) in conjunction with entering said potential patient's subjective responses into said electronic questionnaire, having said representative subjectively evaluate said potential patient's subjective responses such that said representative's subjective evaluation of said potential patient's subjective responses and subsequent entry by said representative of an evaluated response into said electronic questionnaire alters said predetermined significance attributed to one or more of said potential patient's subjective responses initially calculated by said proprietary computer program, thereby allowing said care management entity to better determine if said potential patient is more suitable for management by said care management program;
i) having said computer system calculate said subjective acuity rating component;
j) having said proprietary computer program weigh said objective acuity rating component, said annualized medical treatment cost acuity rating component and said subjective acuity rating component according to parameters assigned by said care management entity; and
k) having said computer system calculate said high risk patient's acuity score from said weighted objective acuity rating component, said weighted annualized medical treatment cost acuity rating component and said weighted subjective acuity rating component, wherein, as a result of said high risk patient's acuity score, said high risk patient is accepted or rejected for participation in said care management program.

6) The method of claim 5 further comprising the steps of:
a) having said care management entity's computer system mine third party databases for mortality, morbidity, medical care and treatment expenditure data associated with high risk patients other than patients managed by said care management entity; and
b) utilizing said computer program to analyze said mined data according to parameters assigned by said care management entity.

7) The method of claim 6 further comprising the step of utilizing a compilation of said analyzed mined data and data stored in said care management entity's computer system for modifying weighting of said objective acuity rating component, said annualized medical treatment cost acuity rating component and said subjective acuity rating component.

8) The method of claim 7, wherein said care management entity's computer system mines one or more of Medicare, Medicaid, mortality, health insurers, Center for Disease Control and health maintenance organization databases.

9) A method for selecting a high risk patient for participation in a care management program for patients having poor prognoses, wherein said care management program is provided by a care management entity not responsible for said high risk patient's diagnosis or prescribed medical treatment, wherein selection of said high risk patient for participation in said care management program is determined by said high risk patient's acuity score, wherein said acuity score is calculated by said care management entity's computer system utilizing a proprietary computer program capable of generating data enterable and viewable electronic templates for use with a multi-component calculation of said acuity score; said method for selecting a high risk patient comprising the steps of:
a) verifying and entering a potential patient's current and past medical conditions into an objective acuity rating component electronic template of said multi-component calculation and having said computer system calculate said objective acuity rating component, wherein said objective acuity rating component is a summation of assigned values for each medical condition, and wherein said values are assigned by said proprietary computer program;
b) verifying and entering said potential patient's prior annualized treatment costs into an annualized medical treatment cost acuity rating electronic template of said multi-component calculation and having said computer system calculate said annualized medical treatment cost acuity rating component, wherein said annualized medical treatment cost acuity rating component is a summation of assigned specific acuity ratings associated with each yearly cost of treatment for up to three preceding years, and wherein said specific acuity ratings are assigned by said proprietary computer program;
c) having said computer system generate an electronic questionnaire, associated with a subjective acuity rating component of said multi-component calculation, for utilization by a representative in conducting a telephonic or in-person interview of said potential patient to solicit subjective responses from said potential patient regarding said potential patient's cognition of said potential patient's daily living status and medical conditions, wherein each of said potential patient's responses has a predetermined numerical significance assigned by said proprietary computer program, and wherein said subjective acuity rating component is a summation of said predetermined numerical significances;
d) in conjunction with entering said potential patient's subjective responses into said electronic questionnaire, having said representative subjectively evaluate said potential patient's subjective responses such that said representative's subjective evaluation of said potential patient's subjective responses and subsequent entry by said representative of an evaluated response into said electronic questionnaire alters said predetermined significance attributed to one or more of said potential patient's subjective responses initially calculated by said proprietary computer program, thereby allowing said care management entity to better determine if said potential patient is more suitable for management by said care management program, and having said computer system calculate said subjective acuity rating component; and
e) having said computer system calculate said high risk patient's acuity score from said objective acuity rating component, said annualized medical treatment cost acuity rating component and said acuity rating component, wherein, as a result of said high risk patient's acuity score, said high risk patient is accepted or rejected for participation in said care management program.

10) The method of claim 9, wherein said summation of said assigned specific acuity ratings does not exceed a fixed limit established by said care management entity.

11) The method of claim 10 further comprising the step of having said proprietary computer program weigh said objective acuity rating component, said annualized medical treatment cost acuity rating component and said subjective acuity rating component according to parameters assigned by said care management entity

12) The method of claim 11 further comprising the steps of:
a) having said care management entity's computer system mine third party databases for mortality, morbidity, medical care and treatment expenditure data associated with high risk patients other than patients managed by said care management entity; and
b) utilizing said computer program to analyze said mined data according to parameters assigned by said care management entity.

13) The method of claim 12 further comprising the step of utilizing a compilation of said analyzed mined data and data stored in said care management entity's computer system for modifying weighting of said objective acuity rating component, said annualized medical treatment cost acuity rating component and said subjective acuity rating component.

14) The method of claim 13, wherein said care management entity's computer system mines one or more of Medicare, Medicaid, mortality, health insurers, Center for Disease Control and health maintenance organization databases.
